(19) United States
(12) Patent Application Publication
(10) Pub. No.: US 2012/0297781 A1
(43) Pub. Date: Nov. 29, 2012

(54) HEATING SYSTEM FOR USE IN A TURBINE ENGINE AND METHOD OF OPERATING SAME

(76) Inventors: Maruthi Prasad Manchikanti, Bestawaripeta (IN); John David Memmer, Simpsonville, SC (US)

(21) Appl. No.: 13/114,752

(22) Filed: May 24, 2011

(51) Int. Cl. F02C 1/00; F01D 5/08

(52) U.S. Cl. 60/772; 415/177

(57) ABSTRACT

A method of operating a turbine engine including coupling a heating assembly to the turbine engine for selectively heating a compressor casing. A sensor transmits a first monitoring signal indicative of a speed of a rotor assembly to a controller. The controller determines whether the turbine engine is operating in a first operating mode based at least in part on the received first monitoring signal, wherein during the first operating mode a minimum clearance distance is defined between the rotor assembly and the compressor casing. The compressor casing of the turbine engine is heated to increase the clearance distance between the compressor casing and the rotor assembly, if the turbine engine is in the first operating mode.

### BACKGROUND OF THE INVENTION

The subject matter described herein relates generally to turbine engine systems and, more particularly, to a heating system for use in a turbine engine system.

At least some known gas turbine engines include a combustor, a compressor coupled downstream from the combustor, a turbine, and a rotor assembly rotatably coupled between the compressor and the turbine. At least some known rotor assemblies include a rotor shaft, at least one rotor disk coupled to the rotor shaft, and a plurality of circumferentially-spaced compressor blades that are coupled to each rotor disk. Each compressor blade includes an airfoil that extends radially outward from a platform towards a compressor casing.

During operation of at least some known turbines, the compressor compresses air, which is mixed with fuel and channeled to the combustor. The mixture is then ignited generating hot combustion gases that are then channeled to the turbine. The turbine extracts energy from the combustion gases for powering the compressor, as well as producing useful work to power a load, such as an electrical generator, or to propel an aircraft in flight.

During operation, the various components of the turbine expand and contract at different and varying rates due in part to thermal expansion resulting from the relatively high temperature associated with turbine operation and due at least partially to mechanical expansion induced by centripetal forces associated with rotation of the rotor assembly. A clearance distance defined between the tips of the blades and the casing is designed to prevent a tip-rub event during operation in which the blade tip contacts the casing. Tip-rub events may induce excessive vibrations and/or damage to the compressor blade and/or the casing. The clearance distance reduces the risk of turbine damage by permitting the blades to expand without contacting the casing. However, if the clearance distance becomes excessive, the efficiency of the turbine may be substantially reduced as a portion of the heated gas flows past the blades without performing useful work.

### BRIEF DESCRIPTION OF THE INVENTION

In one embodiment, a method of operating a turbine engine is provided. The method includes coupling a heating assembly to the turbine engine for selectively heating a compressor casing. A sensor transmits a first monitoring signal indicative of a speed of a rotor assembly to a controller. The controller determines whether the turbine engine is operating in a first operating mode based at least in part on the received first monitoring signal, wherein during the first operating mode a minimum clearance distance is defined between the rotor assembly and the compressor casing. The compressor casing of the turbine engine is heated to increase the clearance distance between the compressor casing and the rotor assembly, if the turbine engine is in the first operating mode.

In another embodiment, a compressor heating system for use with a turbine engine is provided. The turbine engine includes a rotor assembly that is positioned within a compressor casing. The compressor casing heating system includes a heating assembly that is coupled to the compressor for selectively heating the compressor casing. A first sensor is configured to sense a rotational speed of the rotor assembly and to generate a signal indicative of the sensed rotor assembly speed. A controller is coupled to the first sensor and the heating assembly. The controller is configured to determine whether the turbine engine system is operating in a first operating mode based at least in part on the sensed rotor assembly speed, wherein during the first operating mode a minimum clearance distance is defined between the rotor assembly and the compressor casing. The compressor casing of the turbine engine is heated to increase the clearance distance between the compressor casing and the rotor assembly, if the turbine engine is in the first operating mode.

In yet another embodiment, a turbine engine is provided. The turbine engine system includes a compressor that includes a casing, a rotor assembly that is positioned within the compressor casing, and a turbine that is coupled in flow communication with the compressor to receive at least some of the air discharged by said compressor. A generator is coupled to the rotor assembly. A compressor heating system is coupled to the compressor and includes a heating assembly that is coupled to the compressor casing for selectively heating an outer surface of the compressor casing. A first sensor is configured to sense a rotational speed of the rotor assembly and to generate a signal indicative of the sensed rotor assembly speed. A controller is coupled to the first sensor and the heating assembly. The controller is configured to determine whether the turbine engine system is operating in a first operating mode based at least in part on the sensed rotor assembly speed, wherein during the first operating mode a minimum clearance distance is defined between the rotor assembly and the compressor casing. The compressor casing of the turbine engine is heated to increase the clearance distance between the compressor casing and the rotor assembly, if the turbine engine is in the first operating mode.

### BRIEF DESCRIPTION OF THE DRAWINGS

FIG. 1 is a schematic illustration of an exemplary turbine engine system including an exemplary heating assembly.

FIG. 2 is an enlarged cross-sectional view of an exemplary compressor section that may be used with the turbine engine system shown in FIG. 1.

FIG. 3 is an exemplary graph of exemplary traces of a clearance distance that may exist between components during a startup operation of the turbine engine system shown in FIG. 1.

FIG. 4 is a block diagram of an exemplary control system that may be used with the turbine engine system shown in FIG. 1.

FIG. 5 is a flow chart of an exemplary method that may be used to increase a radial clearance between components of the turbine engine system shown in FIG. 1.

### DETAILED DESCRIPTION OF THE INVENTION

The exemplary methods and systems described herein overcome at least some disadvantages of at least some known turbine engine systems by providing a heating system that heats a casing to facilitate thermal expansion of the casing. Moreover, the embodiments described herein include a control system that determines when the turbine engine is operating with a minimum clearance distance, and causes a compressor casing to be heated to thermally expand the compressor casing such that the clearance distance is selectively increased during operation. By heating the compressor casing when the turbine engine is operating with the minimum clearance distance, the clearance distance designed into the turbine engine system can be reduced, thus increasing the operating efficiency of the turbine engine.

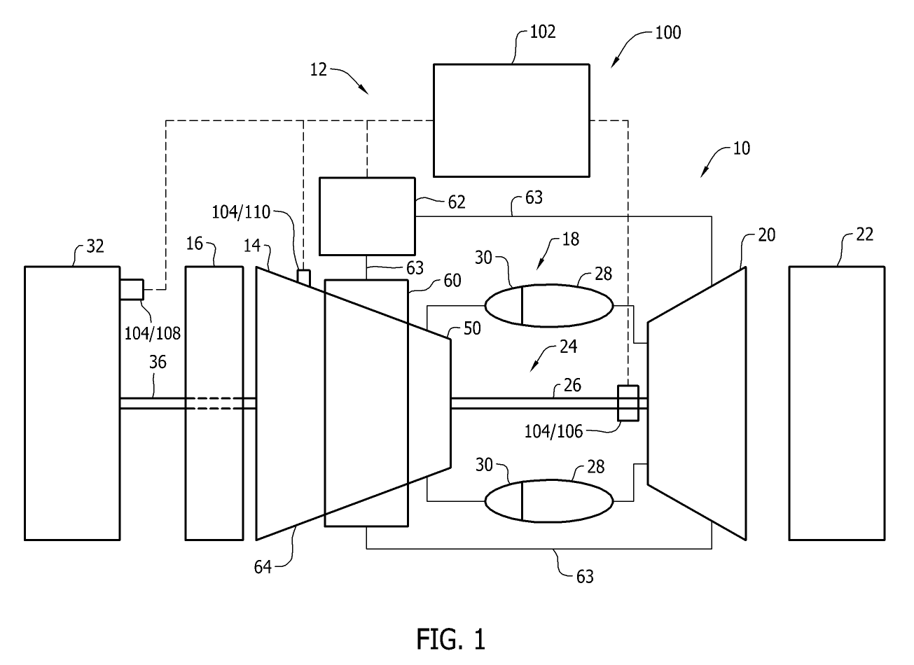

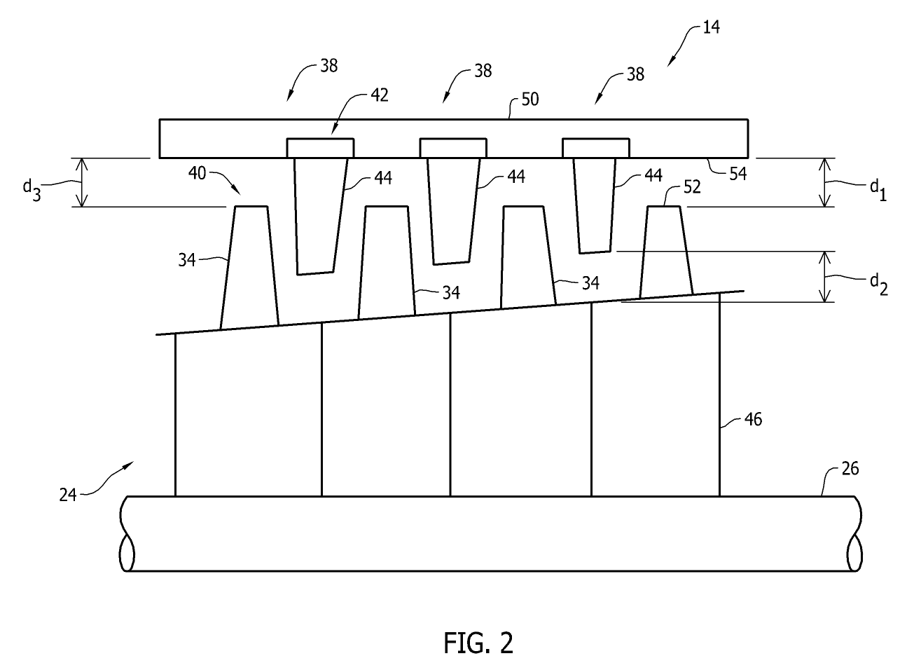

FIG. 1 is a schematic view of an exemplary turbine engine system 10 that includes a heating system 12. FIG. 2 is an enlarged cross-sectional view of an exemplary compressor section 14 that may be used with turbine engine system 10. In the exemplary embodiment, turbine engine system 10 includes an intake section 16, a compressor section 14 coupled downstream from intake section 16, a combustor section 18 coupled downstream from compressor section 14, a turbine section 20 coupled downstream from combustor section 18, and an exhaust section 22. A rotor assembly 24 is coupled to turbine section 20 and compressor section 14 and includes a drive shaft 26 that extends between turbine section 20 and compressor section 14. Combustor section 18 includes a plurality of combustors 28. Combustor section 18 is coupled to compressor section 14 such that each combustor 28 is in flow communication with compressor section 14.

A fuel assembly 30 is coupled to each combustor 28 to provide a flow of fuel to combustor 28. Turbine section 20 is rotatably coupled to compressor section 14 and to an electrical generator 32 with drive shaft 26. Compressor section 14 and turbine section 20 each include at least one rotor blade or compressor blade 34 that is coupled to rotor assembly 24. Rotor assembly 24 includes a rotor 36 that is coupled to generator 32 and that imparts a power loading to generator 32 during operation of turbine engine system 10. Generator 32 is coupled to a power source, such as for example, an electric utility grid (not shown) for distributing electrical power to the utility grid. The turbine engine system 10 may be a 9FA turbine or a similar device offered by General Electric Company of Schenectady, N.Y. Other types of gas turbine engines may be used herein. Turbine engine system 10 may have other configurations and use other types of components. Multiple gas turbine engines, other types of turbines, and/or other types of power generation equipment may be used together.

In the exemplary embodiment, each rotor assembly 24 includes a plurality of stages 38 that each include a row 40 of compressor blades 34 and a stationary row 42 of compressor vanes 44. Each compressor blade 34 extends radially outwardly from a rotor disk 46. Each rotor disk 46 is coupled to drive shaft 26 and rotates about a centerline axis 48 that is defined by drive shaft 26. A compressor casing 50 extends circumferentially about rotor assembly 24 and compressor vanes 44. Each compressor vane 44 is coupled to casing 50 and extends radially inwardly from casing 50 towards rotor disk 46. Each compressor blade 34 extends outwardly towards casing 50 such that a tip end 52 of compressor blade 34 is spaced a radial clearance distance d₁ from an inner surface 54 of casing 50. Similarly, each compressor vane 44 extends inwardly towards rotor disk 46 such that a tip end 56 of each compressor vane 44 is spaced a radial clearance distance d₂ from a radially outer surface 58 of each rotor disk 46.

During operation, intake section 16 channels air towards compressor section 14. Compressor section 14 compresses the inlet air to a higher pressure and temperature and discharges the compressed air towards combustor section 18. Fuel is channeled from fuel assembly 30 to each combustor 28 wherein it is mixed with the compressed air and ignited in combustor section 18. Combustor section 18 channels combustion gases to turbine section 20 wherein gas stream thermal energy is converted to mechanical rotational energy to drive compressor section 14 and/or generator 32. Exhaust gases exit turbine section 20 and flow through exhaust section 22 to ambient atmosphere.

During operation, operating temperatures of rotor assembly 24 and casing 50 may fluctuate to different temperatures which may cause clearance distances d₁ and d₂ to vary over time. Moreover, during operation, clearance distances d₁ and d₂ may vary based on turbine engine system 10 operating parameters such as, for example a rotation speed of rotor assembly 24, material temperatures of rotor assembly 24 and casing 50, and fluid pressures within turbine section 20 and compressor section 14. In the exemplary embodiment, compressor section 14 is designed with a minimum clearance distance d₃ defined between tip end 52 and casing 50 to prevent a tip rub event. As used herein, the term “tip rub event” refers to an event wherein a tip end 52 contacts casing 50 during operation of turbine engine system 10. A tip rub event induces vibrations within compressor section 14 that may cause damage to casing 50, compressor vanes 44, compressor blades 34, rotor disk 46, and/or shaft 26.

In the exemplary embodiment, turbine engine system 10 includes a heating system 12 that increases a temperature of compressor section 14 to enable clearance distances d₁ and/or d₂ to be selectively adjusted during operation of turbine engine system 10. Heating system 12 includes a heating assembly 60 that is coupled to casing 50, and a heat exchanger 62 that is coupled to heating assembly 60 to provide a flow of heating fluid to heating assembly 60. In one embodiment, heat exchanger 62 includes a heat recovery steam generator (HRSG) (not shown) that is coupled to turbine section 20 and to heating assembly 60. Exhaust gases from turbine section 20 are channeled through a plurality of heat transfer lines 63 to the HRSG for use in generating a heating fluid, such as for example steam, from the recovered waste heat from the exhaust gases. The HRSG channels the heating fluid to heating assembly 60 for use in heating casing 50. Heating assembly 60 includes a plurality of tubes (not shown) that are coupled to an outer surface 64 of casing 50. The tubes circumscribe casing 50 to facilitate a transferring heat from heating fluid to casing 50 to increase a temperature of casing 50. Heating assembly 60 is configured to heat outer surface 64 substantially uniformly. In one embodiment, heating assembly 60 may include a plurality of electric resistance heating coils that are coupled to outer surface 64. Alternatively, heat exchanger 62 may be configured to channel exhaust gases from turbine section 20 to heating assembly 60 to facilitate increasing a temperature of casing 50.

In the exemplary embodiment, turbine engine system 10 includes a control system 100 that includes a controller 102 that is coupled in communication with a plurality of sensors 104. Each sensor 104 detects various parameters relative to the operation of and environmental conditions of turbine engine system 10. Sensors 104 may include, but are not limited to only including, temperature sensors, acceleration sensors, fluid pressure sensors, power load sensors, and/or any other sensors that sense various parameters relative to the operation of turbine engine system 10. As used herein, the term “parameters” refers to physical properties whose values can be used to define the operating and environmental conditions of turbine engine system 10, such as temperatures, fluid pressures, electric power loading, rotational speed, and fluid flows at defined locations. In the exemplary embodiment, control system 100 is coupled in operative communication to heat exchanger 62 and heating assembly 60 to adjust a temperature of compressor section 14.

Control system 100 includes a first sensor 106 that is coupled to rotor assembly 24 for sensing a rotational speed of drive shaft 26 and that transmits a signal indicative of the sensed speed to controller 102. A second sensor 108 is coupled to generator 32 for sensing a power load imparted to generator 32 from rotor 36 and that transmits a signal indicative of the sensed power load to controller 102. A third sensor 110 is coupled to compressor section 14 for sensing a temperature of compressor casing 50 and that transmits a signal indicative of the sensed casing temperature to controller 102.

In the exemplary embodiment, controller 102 determines whether clearance distance d₁ and/or d₂ is approximately equal to, or less than, a predefined distance during operation of turbine engine system 10, such as for example, minimum clearance distance d₃ to prevent a tip rub event. Controller 102 also operates heating system 12 to heat casing 50 to facilitate selectively increasing clearance distance d₁ and/or d₂ during operation of turbine engine system 10. By heating casing 50 when clearance distance d₁ is at the minimum clearance distance d₃, clearance distance d₁ is facilitated to be increased, thereby decreasing the minimum clearance distance d₃ that is originally designed into turbine engine system 10 to prevent a tip rub event.

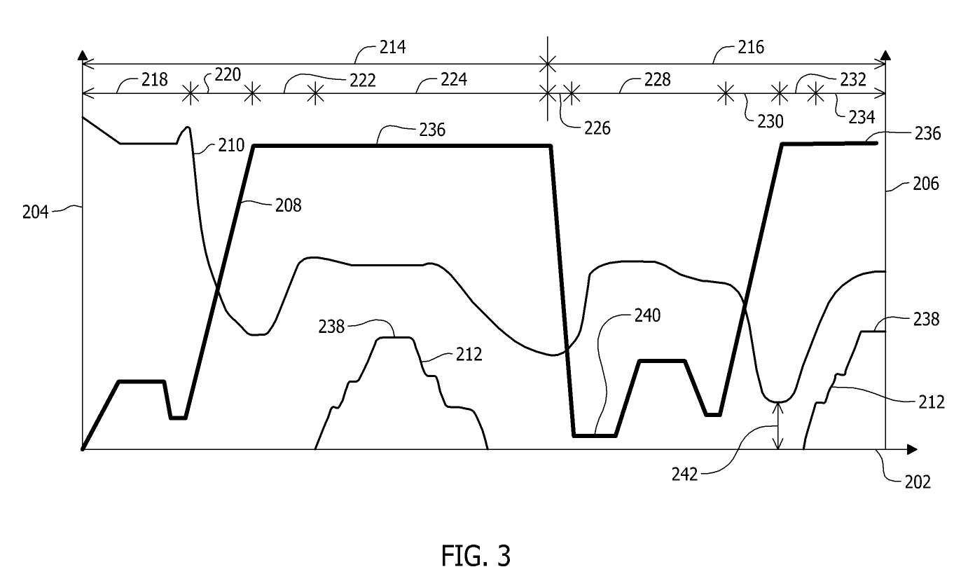

FIG. 3 is an exemplary graph 200 of exemplary traces of clearance distance d₁ that may occur during a startup operation of turbine engine system 10. The X-axis 202 displays time. The Y₁-axis 204 displays a speed of rotation of rotor assembly 24. The Y₂-axis 206 displays a power loading of generator 32. Trace 208 represents the rotational speed of rotor assembly 24. Trace 210 represents clearance distance d₁. Trace 212 represents a power loading of generator 32 over time. During a startup operation of turbine engine system 10, turbine engine system 10 is operated through a sequence of operating cycles that each include a plurality of operating phases. In the exemplary embodiment, the startup operation of turbine engine system 10 includes a cold-start operating cycle 214 and a hot-restart operating cycle 216. During cold-start operating cycle 214, turbine engine system 10 is sequentially operated in a plurality of operating phases that include a first purge phase 218, a first rotor assembly speed ramp-up phase 220, a first full-speed no-load (FSNL) phase 222, and a first full-speed full-load (FSFL) phase 224. Hot-restart operating cycle 216 includes a plurality of sequential operating phases that include a rotor assembly speed ramp-down phase 226, a second purge phase 228, a second rotor assembly speed ramp-up phase 230, a second FSNL phase 232, and a second FSFL phase 234.

During operation of turbine engine system 10 in cold-start operating cycle 214, a purging fluid, such as for example air, is channeled through turbine engine system 10 to remove fluid voids and/or air pockets during first purge phase 218. A rotational speed of rotor assembly 24 is then increased at a predefined rate of acceleration during first speed ramp-up phase 220 causing an increase in a temperature of casing 50 and rotor assembly 24. Turbine engine system 10 is then operated in first FSNL phase 222 wherein rotor assembly 24 is rotated at a full speed 236 with no electrical power load imparted to generator 32. After completion of first FSNL phase 222, turbine engine system 10 is operated in first FSFL phase 224 wherein a full electrical power load 238 is imparted to generator 32 with rotor assembly 24 at full speed. After operating in first FSFL phase 224 for a predefined period of time, turbine engine system 10 is operated in speed ramp-down phase 226 wherein no power load is imparted to generator 32 and rotor assembly speed is reduced at a predefined rate of deceleration until rotor assembly 24 has reached a minimum rotational speed 240 that is less than full speed 236.

After completing cold-start operating cycle 214, turbine engine system 10 is operated in hot-restart operating cycle 216. During second purge phase 228, purging fluid is channeled through turbine engine system 10 to remove fluid voids and/or air pockets. The purging fluid facilitates a transfer of heat from casing 50 to the purging fluid causing a temperature of casing 50 to be reduced. After completing second purge phase 228, the rotational speed of rotor assembly 24 is increased during second speed ramp-up phase 230 until rotor assembly 24 is operating in second FSNL phase 232 at full speed 236 and no electrical power load. After completing second FSNL phase 232, a power load is applied and turbine engine system 10 is operated in second FSFL phase 234 wherein full electrical power load 238 is imparted to generator 32 with rotor assembly 24 at full speed 236.

In the exemplary embodiment, during second purge phase 228, a temperature of casing 50 is different from rotor assembly 24. In addition, clearance distance d₁ is reduced based at least in part on a thermal contraction of casing 50 caused by the reduction in casing temperature. During second FSNL phase 232, clearance distance d₁ includes a minimum clearance distance 242 between rotor assembly 24 and casing 50. In addition, internal fluid pressures and thermal expansion within casing 50 may cause casing 50 to deform from a substantially round cross-sectional shape to a substantially oblong cross-sectional shape. In the exemplary embodiment, heating assembly 60 is configured to increase a temperature of casing 50 before, during, and/or after second FSNL phase 232 to increase clearance distance d₁ during second FSNL phase 232 to facilitate increasing minimum clearance distance 242 and to prevent a tip rub event. Moreover, heating assembly 60 is also configured to apply a uniform heat across casing outer surface 64 to uniformly heat casing 50 to facilitate reducing a circumferential deformation of casing 50.

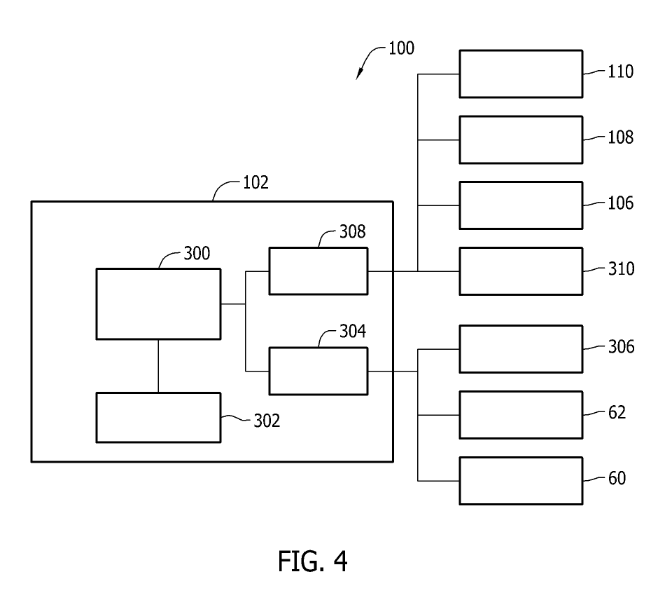

FIG. 4 is a block diagram of an exemplary control system 100. In the exemplary embodiment, controller 102 includes a processor 300 and a memory device 302. Processor 300 includes any suitable programmable circuit which may include one or more systems and microcontrollers, microprocessors, reduced instruction set circuits (RISC), application specific integrated circuits (ASIC), programmable logic circuits (PLC), field programmable gate arrays (FPGA), and any other circuit capable of executing the functions described herein. The above examples are exemplary only, and thus are not intended to limit in any way the definition and/or meaning of the term “processor.” Memory device 302 includes a computer readable medium, such as, without limitation, random access memory (RAM), flash memory, a hard disk drive, a solid state drive, a diskette, a flash drive, a compact disc, a digital video disc, and/or any suitable device that enables processor 300 to store, retrieve, and/or execute instructions and/or data.

In the exemplary embodiment, controller 102 includes a control interface 304 that controls operation of heating system 12. Control interface 304 is coupled to one or more control devices 306, such as, for example, heat exchanger 62 and/or heating assembly 60. Controller 102 also includes a sensor interface 308 that is coupled to at least one sensor 310 such as, for example, first, second, and third sensors 106, 108, and 110. Each sensor 310 transmits a signal corresponding to a sensed operating parameter of casing 50, generator 32, and/or rotor assembly 24. Each sensor 310 may transmit a signal continuously, periodically, or only once and/or any other signal timing that enable control system 100 to function as described herein. Moreover, each sensor 310 may transmit a signal either in an analog form or in a digital form.

Various connections are available between control interface 304 and control device 306, between sensor interface 308 and sensors 310, and between processor 300 and memory device 302. Such connections may include, without limitation, an electrical conductor, a low-level serial data connection, such as Recommended Standard (RS) 232 or RS-485, a high-level serial data connection, such as Universal Serial Bus (USB) or Institute of Electrical and Electronics Engineers (IEEE) 1394 (a/k/a FIREWIRE), a parallel data connection, such as IEEE 1284 or IEEE 488, a short-range wireless communication channel such as BLUETOOTH, and/or a private (e.g., inaccessible outside power generation system 10) network connection, whether wired or wireless.

In the exemplary embodiment, turbine engine system 10 is operated in a plurality of modes. Controller 102 receives a signal from first sensor 106 that is indicative of a rotational speed of rotor assembly 24 and determines whether turbine engine system 10 is operating in a first operating mode that includes minimum clearance distance 242 based at least in part on the sensed rotor assembly speed. Controller 102 selectively operates heating system 12 to increase a temperature of casing 50 to increase clearance distance d₁ when turbine engine system 10 is operating in the first operating mode. Controller 102 also receives a signal from second sensor 108 that is indicative of a power loading imparted to generator 32 from rotor 36 and determines whether turbine engine system 10 is operating in the first operating mode based at least in part on the sensed generator power load. In the exemplary embodiment, controller 102 determines turbine engine system 10 to be operating at minimum clearance distance 242 when rotor assembly 24 is rotated at full speed 236 and when generator 32 is at a no electrical power load.

In the exemplary embodiment, controller 102 determines turbine engine system 10 to be operating at minimum clearance distance 242 when turbine engine system 10 has completed cold-start operating cycle 214, and is operating in hot-restart operating cycle 216. In addition, controller 102 determines turbine engine system 10 to be operating at minimum clearance distance 242 when turbine engine system 10 is in second FSNL phase 232.

In one embodiment, controller 102 receives a signal from third sensor 110 that is indicative of a temperature of casing 50 and determines turbine engine system 10 to be operating in second purge phase 228 based at least in part on the sensed casing temperature. Moreover, controller 102 determines turbine engine system 10 to be in second purge phase 228 if the sensed casing temperature is less than a predefined temperature, and/or if the rate of reduction in the sensed casing temperature is approximately equal to a predefined rate. Controller 102 determines turbine engine system 10 to be operating at minimum clearance distance 242 after completing second purge phase 228.

In the exemplary embodiment, controller 102 selectively heats casing 50 for a predefined period of time when turbine engine system 10 is operating in second FSNL phase 232. In one embodiment, controller 102 heats casing 50 for a period of about twenty minutes before and/or during second FSNL phase 232. Alternatively, controller 102 heats casing 50 during second FSNL phase 232 such that clearance distance d₁ is increased by about 10 mils to about 15 mils during second FSNL phase 232.

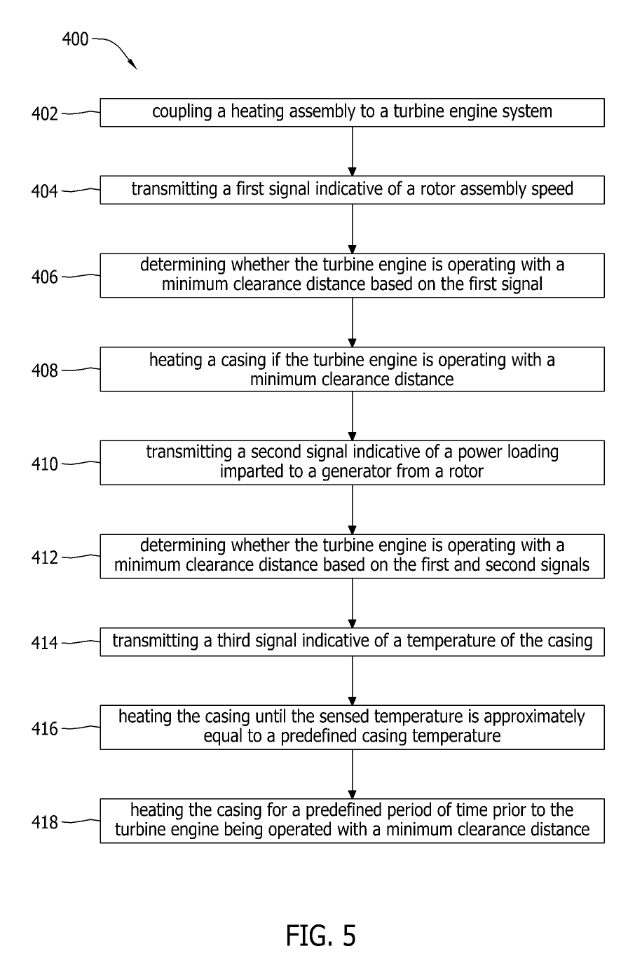

FIG. 5 is a flow chart of an exemplary method 400 that may be used to increase a radial clearance defined between components of turbine engine system 10. In the exemplary embodiment, method 400 includes coupling 402 heating assembly 60 to turbine engine system 10, and transmitting 404 a first monitoring signal that is indicative of a speed of rotor assembly 24 to controller 102. Controller 102 determines 406 whether turbine engine system 10 is operating in a first operating mode based at least in part on the received first monitoring signal, wherein the first operating mode includes a minimum clearance distance 242 between rotor assembly 24 and casing 50. Heating system 12 heats 408 casing 50 if turbine engine system 10 is in the first operating mode to increase the clearance distance d₁ between casing 50 and rotor assembly 24.

Method 400 also includes transmitting 410 a second monitoring signal that is indicative of a power loading imparted to generator 32 from rotor 36, and determining 412 whether turbine engine system 10 is operating in the first operating mode, based at least in part on the first and second monitoring signals. In one embodiment, method 400 includes determining turbine engine system 10 to be in the first operational mode after determining that rotor assembly 24 is at a full speed condition, and after determining that generator 32 is at a no power load condition. Alternatively, method 400 may include determining whether turbine engine system 10 is in a purge operational mode, and determining turbine engine system 10 to be in the first operational mode after the purge operational mode. In the exemplary embodiment, method 400 includes transmitting 414 a third monitoring signal indicative of a temperature of casing 50, and heating 416 compressor section 14 until the sensed temperature is approximately equal to a predefined casing temperature.

In an alternative embodiment, method 400 includes heating 418 casing for a predefined period of time prior to turbine engine system 10 being operated in the first operational mode. Method 400 also includes heating casing 50 such that the operational clearance distance between rotor assembly 24 and casing 50 is increased about 10 mils and 15 mils. In one embodiment, casing 50 is heated such that a circumference of casing 50 is substantially uniformly heated to facilitate reducing circumferential deformation of casing 50.

The orientation and position of heating system 12 is selected to facilitate increasing a temperature of casing 50 when turbine engine system 10 is operating with a minimum clearance distance d₃ defined between compressor blade 34 and casing 50 to increase clearance distance d₁ during operation of turbine engine system 10. In addition, by determining when turbine engine system 10 is operating with the minimum clearance distance and heating casing 50 to increase clearance distance d₁, the clearance distance designed into turbine engine system 10 can be reduced to facilitate turbine engine system 10 operating at a higher efficiency than known turbine engines.

The above-described systems and methods overcome at least some disadvantages of known turbine engine systems by selectively heating the casing to increase the minimum clearance distance during operation of the turbine engine system. Moreover, the embodiments described herein include a control system that determines when the turbine engine is operating with a minimum clearance distance, and causes a casing to be heated to thermally expand the casing and selectively increase the clearance distance during operation. As such, the clearance distance originally designed into the turbine engine system can be reduced, thus enabling the turbine engine system to operate with a higher operational efficiency than known turbine engine systems, thereby reducing the costs of operating the turbine engine and extending the operational life of the turbine engine.

An exemplary technical effect of the methods, system, and apparatus described herein includes at least one of: (a) transmitting, from a sensor to a controller, a first monitoring signal indicative of a speed of the rotor assembly; (b) transmitting, from the sensor to the controller, a second monitoring signal indicative of a power loading imparted to a generator from the rotor assembly; (c) determining, by the controller, whether the turbine engine is operating in a first operating mode based at least in part on the received first and second monitoring signals, wherein the first operating mode includes a minimum clearance distance between the rotor assembly and the compressor casing; and (d) heating the compressor casing if the turbine engine is in the first operating mode to increase the clearance distance between the compressor casing and the rotor assembly.

Exemplary embodiments of a heating system and methods for operating the same are described above in detail. The systems and methods are not limited to the specific embodiments described herein, but rather, components of the systems and/or steps of the methods may be utilized independently and separately from other components and/or steps described herein. For example, the methods may also be used in combination with other power generation systems, and are not limited to practice with only the turbine engine system as described herein. Rather, the exemplary embodiment can be implemented and utilized in connection with many other power generation system applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of operating a turbine engine, said method comprising:
coupling a heating assembly to the turbine engine for selectively heating a compressor casing;
transmitting, from a sensor to a controller, a first monitoring signal indicative of a speed of a rotor assembly;
determining, by the controller, whether the turbine engine is operating in a first operating mode based at least in part on the received first monitoring signal, wherein during the first operating mode a minimum clearance distance is defined between the rotor assembly and the compressor casing; and
heating the compressor casing of the turbine engine to increase the clearance distance between the compressor casing and the rotor assembly, if the turbine engine is in the first operating mode.

2. A method in accordance with claim 1, further comprising:
transmitting, from the sensor to the controller, a second monitoring signal indicative of a power loading imparted to a generator from the rotor assembly; and
determining whether the turbine engine is operating in the first operating mode based at least in part on the first and second monitoring signals.

3. A method in accordance with claim 2, further comprising:
transmitting, by the sensing to the controller, a third monitoring signal indicative of a temperature of the compressor casing; and
heating the compressor until the sensed temperature is approximately equal to a predefined casing temperature.

4. A method in accordance with claim 2, further comprising determining the turbine engine to be in the first operational mode after determining that the rotor assembly is at a full speed condition, and after determining that the generator is at a no power load condition.

5. A method in accordance with claim 1, further comprising heating the compressor casing for a predefined period prior to the turbine engine operating in the first operational mode.

6. A method in accordance with claim 1, further comprising:
determining whether the turbine engine is in a purge operational mode; and
determining the turbine engine to be in the first operational mode after the purge operational mode.

7. A method in accordance with claim 1, further comprising heating the compressor casing such that a circumference of the compressor casing is uniformly heated to facilitate reducing circumferential deformation of the compressor casing.

8. A method in accordance with claim 1, further comprising heating the compressor casing such that the operational clearance distance between the rotor assembly and casing is increased about 10 mils to about 15 mils.

9. A compressor heating system for use with a turbine engine, said compressor casing heating system comprising:
a heating assembly coupled to a compressor for selectively heating a compressor casing;
a first sensor configured to sense a rotational speed of a rotor assembly and to generate a signal indicative of the sensed rotor assembly speed; and
a controller coupled to said first sensor and said heating assembly, said controller configured to:
determine whether the turbine engine is operating in a first operating mode based at least in part on the sensed rotor assembly speed, wherein during the first operating mode a minimum clearance distance is defined between the rotor assembly and the compressor casing; and
heat the compressor casing of the turbine engine to increase the clearance distance between the compressor casing and the rotor assembly, if the turbine engine is in the first operating mode.

10. A compressor heating system in accordance with claim 9, wherein said rotor assembly is rotatably coupled to a generator, said compressor heating system further comprises a second sensor configured to sense a power loading imparted to the generator from the rotor assembly and to generate a signal indicative of the sensed generator power loading, said controller configured to determine whether the turbine engine is operating in the first operating mode based at least in part on the sensed generator power loading.

11. A compressor heating system in accordance with claim 10, wherein said controller is configured to determine the turbine engine to be in the first operational mode when the rotor assembly is rotating at full speed and the generator is at a no power load condition.

12. A compressor heating system in accordance with claim 10, further comprising a third sensor configured to sense a temperature of the compressor casing and to generator a signal indicative of the sensed casing temperature, said controller configured to heat the compressor until the sensed temperature is approximately equal to a predefined casing temperature.

13. A compressor heating system in accordance with claim 9, wherein said controller is further configured to heat the compressor casing for a predefined period of time prior to the turbine engine operating in the first operational mode.

14. A compressor heating system in accordance with claim 9, wherein said controller is further configured to determine whether the turbine engine is in a purge operational mode, and to determine the turbine engine to be in the first operational mode after the purge operational mode.

15. A compressor heating system in accordance with claim 9, wherein said heating assembly is configured to uniformly heat an outer surface of the compressor casing to facilitate reducing circumferential deformation of the compressor casing.

16. A turbine engine comprising:
a compressor comprising a casing;
a rotor assembly positioned within said compressor casing;
a turbine coupled in flow communication with said compressor to receive at least some of the air discharged by said compressor;
a generator coupled to said rotor assembly; and
a compressor heating system coupled to said compressor, said compressor casing heating system comprising:
a heating assembly coupled to said compressor casing for selectively heating an outer surface of said compressor casing;
a first sensor configured to sense a rotational speed of said rotor assembly and to generate a signal indicative of the sensed rotor assembly speed; and
a controller coupled to said first sensor and said heating assembly, said controller configured to:
determine whether said turbine engine system is operating in a first operating mode based at least in part on the sensed rotor assembly speed, wherein during the first operating mode a minimum clearance distance is defined between said rotor assembly and said compressor casing; and
heat the compressor casing of the turbine engine to increase the clearance distance between the compressor casing and the rotor assembly, if the turbine engine is in the first operating mode.

17. A turbine engine in accordance with claim 16, wherein said compressor heating system further comprises a second sensor configured to sense a power loading imparted to said rotor assembly from said generator and to generate a signal indicative of the sensed generator power loading, said controller configured to determine whether said turbine engine system is operating in the first operating mode based at least in part on the sensed generator power loading.

18. A turbine engine in accordance with claim 17, wherein said controller is configured to determine said turbine engine system to be in the first operational mode when said rotor assembly is rotating at a full speed and said generator is at a no power load condition.

19. A turbine engine in accordance with claim 17, wherein said compressor heating system further comprises a third sensor configured to sense a temperature of said compressor casing and to generate a signal indicative of the sensed casing temperature, wherein said controller configured to heat said compressor until the sensed temperature is approximately equal to a predefined casing temperature.

20. A turbine engine in accordance with claim 17, wherein said heating assembly is configured to uniformly heat said casing outer surface to facilitate reducing circumferential deformation of said compressor casing.
